(19) United States
(12) Patent Application Publication
(10) Pub. No.: US 2013/0046660 A1
(43) Pub. Date: Feb. 21, 2013

(54) Taxable Fringe Benefit Accounting for Electric Vehicle Charging Service

(71) Applicants: Richard Lowenthal, Cupertino, CA (US); Jonathan Kaplan, Saratoga, CA (US); James Solomon, Saratoga, CA (US)

(72) Inventors: Richard Lowenthal, Cupertino, CA (US); Jonathan Kaplan, Saratoga, CA (US); James Solomon, Saratoga, CA (US)

(21) Appl. No.: 13/211,257

(22) Filed: Aug. 16, 2011

(51) Int. Cl. G06Q 40/00

(52) U.S. Cl. 705/30

(57) ABSTRACT

A charging station network server receives a message that indicates a set of parameters of an electric vehicle charging session. The set of parameters provides an indication of an electric vehicle operator associated with the charging session. The server determines that at least a portion of a cost of the electric vehicle charging session is to be paid by an employer of the electric vehicle operator. The server determines a fair market value of the electric vehicle charging session reduced by any amount that is not paid by the employer. The server stores, in association with a profile of the electric vehicle operator, the determined fair market value of the electric vehicle charging session reduced by any amount that is not paid by the employer.

### BACKGROUND

1. Field

Embodiments of the invention relate to the field of charging electric vehicles; and more specifically to accounting for employees' use of electric vehicle charging stations for taxable fringe benefit purposes.

2. Background

Electric vehicle charging stations (hereinafter “charging stations”) are used to charge electric vehicles (e.g., electric battery powered vehicles, gasoline/electric battery powered vehicle hybrids, etc.). Charging stations may be located in designated charging locations (e.g., similar to a gas station), parking spaces (e.g., public parking spaces and/or private parking space), private residences, etc. Charging stations may be controlled (e.g., owned or leased) by governments, businesses, utilities, organizations, or other entities. Some charging station owners may sell electric vehicle charging service to customers.

Employers may pay for at least some of the cost for their employees' personal electric vehicle charging service use (e.g., to charge electric vehicles for personal use). For example, an employer that owns or controls charging station(s) may permit their employees to use their charging station(s) to charge electric vehicles for personal use (non-work related use) at a discounted price or no price. As another example, employers that do not own or control charging station(s) may pay for at least some of the cost for their employees' personal use of electric vehicle charging service. An employee's electric vehicle charging service for personal use (e.g., non-work related use) that is paid by the employer is a fringe benefit. A fringe benefit is a form of pay in addition to stated pay for the performance of services (e.g., regular wages paid to the employee). The value of the fringe benefit of paying for electric vehicle charging service may be such that it qualifies as a taxable fringe benefit.

### BRIEF DESCRIPTION OF THE DRAWINGS

The invention may best be understood by referring to the following description and accompanying drawings that are used to illustrate embodiments of the invention. In the drawings:

FIG. 1 illustrates an exemplary electric vehicle charging station network according to one embodiment of the invention;

FIG. 2 is a block diagram illustrating the server illustrated in FIG. 1 according to some embodiments of the invention;

FIG. 3 is a flow diagram illustrating exemplary operations performed at a charging station in the network of FIG. 1 according to one embodiment of the invention;

FIG. 4 is a flow diagram illustrating exemplary operations for an accounting procedure for employee pricing according to one embodiment of the invention;

FIG. 5 illustrates exemplary portals of the charging station network server of FIG. 1 according to one embodiment of the invention;

FIG. 6 is a flow diagram illustrating exemplary operations for defining employee pricing according to one embodiment of the invention; and

FIG. 7 illustrates an exemplary embodiment of a charging station according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

A method and apparatus for taxable fringe benefit accounting for electric vehicle charging service is described. An employee's electric vehicle charging service for personal (e.g., non-work related use) that is paid by the employer is a fringe benefit. The electric vehicle charging service may include use of the charging station for charging the electric vehicle and optionally any associated parking fees. A fringe benefit is a form of pay in addition to stated pay for the performance of services (e.g., regular wages paid to the employee). The value of the fringe benefit of paying for electric vehicle charging service may be such that it qualifies as a taxable fringe benefit. The taxable fringe benefit is typically valued at its fair market value (FMV) of the electric vehicle charging service.

In one embodiment, an employer configures the electric vehicle charging service such that the employer pays for at least a portion of the cost of the charging service for their employees' personal use. The FMV of the charging service that is paid by the employer for a particular employee's personal use (e.g., to charge their personal electric vehicle for personal use and optionally any parking) may be automatically determined such that it can be included in the employee's wages and reported to the appropriate taxing authorities when and as required (e.g., if the FMV of the charging service exceeds a minimum amount prescribed by the appropriate taxing authorities). The employer may configure the amount it pays for employees' personal charging use to be capped at a certain amount per employee (e.g., one hundred dollars per month, one thousand dollars per year, etc.), which may or may not be equivalent to a maximum amount prescribed by the appropriate taxing authorities. Any amount over the cap is the responsibility of the employee.

In one embodiment, the employer defines pricing for employees' personal use of electric vehicle charging service (hereinafter referred to as “employee pricing”) at a reduced price (e.g., a percentage of the cost of the EV charging service) or no price. The employer may define the employee pricing using an interface on a server that is networked with the charging stations. The employee pricing may be defined differently for different charging stations and may be different for different times and/or dates. The employer can define employee pricing differently for different employees. For example, some employees may have (sometimes different) reduced rates while other employees are not charged.

The employee pricing may be defined flexibly. For example, the employee pricing may be defined differently with respect for different ways the charging service is billed, which may or may not be defined by the employer.

In some cases the employer is also a charging station host. A host is an entity that owns or controls one or more charging stations (and possibly their associated parking space(s)) and may sell electric vehicle charging service. In such a case, the employer can establish a pricing plan used for the charging service including: per charging session; per hour (or other length of time) elapsed during the charging session; per amount of energy transferred (e.g., kilowatt-hour (kWh)) during the charging session; and any combination thereof and may include the cost of an associated parking space. As used herein, a charging session is a limited period of time, which may be configurable by the charging station owner, during which energy may be transferred between a particular electric vehicle and a charging station. When the pricing plan is per charging session, the cost of the charging session is irrespective of the actual amount of energy transferred (e.g., in kilowatt-hours (kWhs)) during the charging session. An employer may configure the employee pricing differently for the different pricing plans. In one embodiment, sometime after an employer has defined the employee pricing for charging electric vehicles on one or more charging stations, the server transmits the pricing to that charging station or another device coupled with the charging station (e.g., a payment station). The charging station (or other device) interprets the pricing and can display appropriate price(s) for charging electric vehicles.

In some circumstances an employer does not define employee pricing as the pricing is established by a different entity. For example, in cases where the employer does not own or control charging stations and does not sell electric vehicle charging service, the charging station owner may establish the pricing for the employees of the employer. For example, the employer may have an agreement with a charging station owner to pay a certain amount for personal electric vehicle charging service of its employees.

The FMV calculation of the electric vehicle charging service provided by the employer may be different depending on the way the electric vehicle charging service is priced. In general, the FMV of the electric vehicle charging service is the amount a willing electric vehicle operator (buyer) would pay for electric vehicle charging service from a seller where neither the operator nor seller is under compulsion to enter into the transaction and both have reasonable knowledge of the facts of the transaction.

For example, the FMV of a pricing plan based on a per charging session basis (irrespective of the actual amount of energy transferred) is determined based on the amount a willing electric vehicle operator would pay for a charging session. In one embodiment, the FMV amount is estimated based on the usual rate that host(s) charge non-employees for charging sessions that share similar circumstances (e.g., similar jurisdiction, similar electric vehicle, etc.).

As another example, the FMV of a pricing plan that is based on per hour (or other length of time) is determined based on the amount that a willing electric vehicle operator would pay for electric vehicle charging service that is billed per hour (or other length of time).

As yet a further example, the FMV of a pricing plan that is based on the amount of energy transferred during the charging session is determined based on the amount that a willing electric vehicle operator would pay for electric vehicle charging service that is billed based on the amount of energy transferred. In one embodiment, the amount is estimated based on the usual rate that host(s) charge non-employees for charging service that is billed based on the amount of energy transfer that share similar circumstances with the employee (e.g., similar jurisdiction, similar electric vehicle, similar kilowatt cost, etc.).

In one embodiment, the FMV calculation is performed by the charging station while in other embodiments it is performed by a server or other device networked with the charging station.

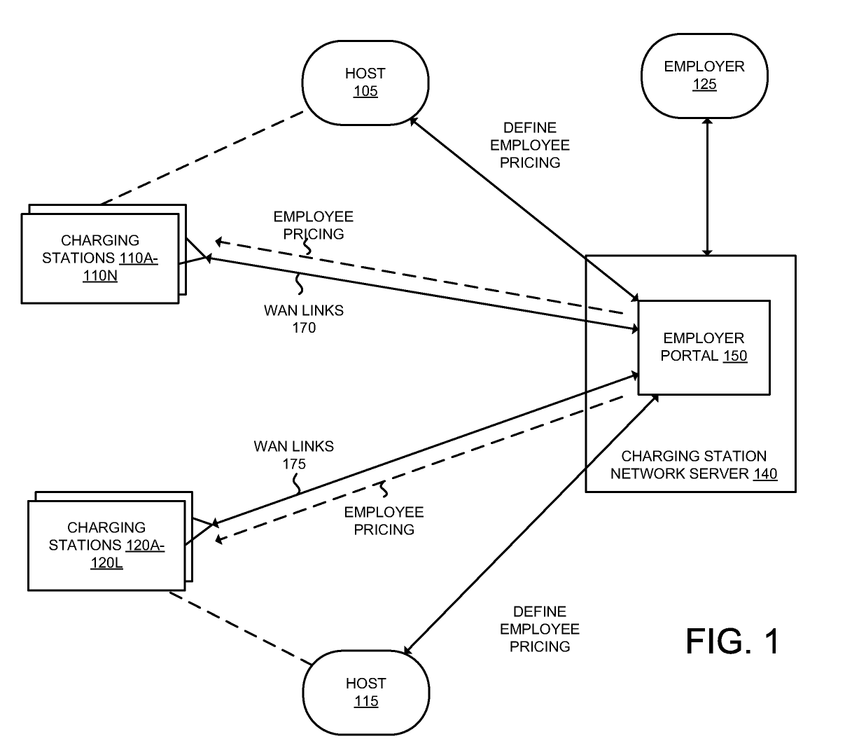

FIG. 1 illustrates an exemplary electric vehicle charging station network according to one embodiment of the invention. The host 105 owns and/or controls the charging stations 110A-110N and the host 115 owns and/or controls the charging stations 120A-120L. Each of the hosts 105 and 115 may be a corporation, a utility, a government, an apartment/condo owner, or other entity that controls (e.g., owns or leases) charging stations. By way of example, the host 105 sells electric vehicle charging service while the host 115 does not sell electric vehicle charging service.

The charging stations 110A-110N and 120A-120L are coupled with the charging station network server (hereinafter “server”) 140. The server 140 is owned and administered by a network operator (not illustrated) and may be a different entity than at least one of the hosts 105 and 115. The network operator may design and/or sell the charging stations 110A-110N and 120A-120L.

The charging stations 110A-110N and 120A-120L are used to charge electric vehicles (e.g., electric battery powered vehicles, gasoline/electric battery powered vehicle hybrids, etc.). The charging stations 110A-110N and 120A-120L may include different charging connection types. For example, some of the charging stations may include one or more attached charging cords (e.g., with a connector conforming to SAE J1772) for charging electric vehicles while other charging stations may include a standard power receptacle (e.g. conforming to NEMA (National Electrical Manufacturers Association) standards 5-15, 5-20, 14-50 or other standards (e.g., BS 1363, CEE7, etc.) and may be operating at different voltages (e.g., 120V, 240V, 230V, etc.)). Still other charging stations may include both an attached charging cord and a power receptacle for charging electric vehicles (sometimes simultaneously).

The charging stations 110A-110N and 120A-120L may be located in public places or private places, and may be configured by the hosts 105 and 115 respectively to operate in restricted mode (available only to certain electric vehicle operators such as their employees) or open mode (available to all electric vehicle operators), which may vary depending on the time of day and/or date. For example, some charging stations may be configured to operate in restricted mode during the day (e.g., during the workday) and open mode during evening and overnight hours, or vice versa. In one embodiment, the charging stations that operate in restricted mode include a restricted list of identifiers (e.g., a whitelist) that identifies those electric vehicle operators which are allowed to use the charging station at that time.

For exemplary purposes, the hosts 105 and 115 are employers that configure employee pricing for at least some of their employees. For example, the hosts 105 and 115 use the employer portal 150 to configure employee pricing for at least some of their employees. The employer portal 150 is accessible to the hosts 105 and 115 over the Internet or other network connection. However, it should be understood that employers that are not hosts can configure employee pricing for at least some of their employees. For example, the employer 125, which is not a host, can also use the employer portal 150 to configure employee pricing for at least some of its employees. The hosts 105 and 115 may also use the employer portal 150 (or a similar portal) to configure pricing for employees of a different employer (e.g., the employer 125). For example, the employer 125, which may not own or operate charging stations, may have an agreement with the host 105 to pay for at least part of the personal electric vehicle charging service provided by the host 105 to the employees of the employer 125.

In one embodiment an electric vehicle operator requests charging service at a charging station. The request may be received directly at the charging station or received at a different entity (e.g., a controller coupled with the charging station, a payment station coupled with the charging station, or a server coupled with the charging station).

Operators of electric vehicles may be required to be authorized in order to use a particular charging station and/or charging connection type. For example, an employee may need to be authorized in order to use a particular charging station and/or charging connection type for personal use. In one embodiment, the request for charging service includes an access identifier. In one embodiment, each employee is associated with a unique identifier that is used for electric vehicle charging service for personal use. In one embodiment, the unique identifier is included in an RFID enabled device that is assigned to the employee for personal use of electric vehicle charging service (the employee may have a different RFID enabled device that is to be used for charging service for work related purposes). In one embodiment, a portion of a unique identifier included in an RFID enabled device identifies an employee while another portion of the identifier identifies the employer. The employee swipes/waves the RFID enabled device near an RFID reader of the charging station (or the controller and/or payment station coupled with charging station) to present the access identifier and request the charging service. In another embodiment, the unique identifier is a different identifier that is uniquely associated with the employee (e.g., a username/password, an email address, a phone number, an address, an employee ID, an account number, a PIN (personal identification number), etc.), in which the employee may enter into a user interface provided on the charging station and/or payment station coupled with the charging station.

In another embodiment, employees register their personal electric vehicles for the service by providing a VIN (vehicle identification number) or other identifier associated with their personal electric vehicles. In some embodiments, the electric vehicles automatically request charging service from the charging station using the identifier (e.g., VIN) when coupled with the charging station (either wirelessly or wired through PLC (power line communication)). The request can also include payment information (e.g., credit card information).

In one embodiment, the charging station (or the controller or payment station) transmits the request to the server 140 for authorization. The authorization request transmitted to the server 140 includes the access identifier and may also include an identifier of the charging station that uniquely identifies the charging station. With respect to FIG. 1, the charging stations 110A-110N and 120A-120L communicate with the server 140 over the WAN (Wide Access Connection) links 170 and 175 respectively to transmit the authorization request and receive authorization reply messages. As will be described later herein, the charging stations 110A-N and 120A-L transmit charging session data to the server 140 and may receive pricing from the server 140 over the links 170 and 175 respectively. The links 170 and 175 may be a cellular link (e.g., CDMA, GPRS, etc.), WiFi internet connection, Plain Old Telephone Service (POTS), leased line, etc. Although not illustrated in FIG. 1, in some embodiments one or more of the charging stations 110A-110N and 120A-120L may not directly communicate with the server 140 but communicate indirectly through a gateway device, which may be one of the charging stations 110A-110N and 120A-120L. In some embodiments, the charging stations communicate with a charging station network server over a Local Area Network (LAN).

The server 140 typically performs authorizing and accounting procedures based at least in part on the access identifier provided in the request. For example, the server may compare the access identifier with a list of identifiers that are authorized for access (e.g., a whitelist of identifiers) and/or against a list of identifiers not authorized for access (e.g., a blacklist of identifiers). The authorization may also depend on other factors including time and/or date of the request, present electrical load on the grid, etc. The server may also perform payment authorization including determining whether a credit card is valid, whether a pre-paid account associated with the identifier has sufficient credits for the charging service, whether a subscription account associated with the identifier is in good standing, etc.

In one embodiment, the server 140 determines whether the access identifier is associated with an employee and is for personal use of the electric vehicle charging service. In such a case, the server may then determine the price for the charging service that the employee is responsible for if any, and may transmit the employee pricing back to the requesting charging station in order to display that price to the employee.

Assuming that the electric vehicle operator is authorized for charging service, the server 140 transmits an authorization reply to the charging station (or payment station or controller) that indicates that charging is allowed. The charging stations 110A-110N and 120A-120L may not be energized until authorization is complete and successful. For example, the charging stations may include a current control device that controls the electric current available for charging electric vehicles and does not allow charging until authorization is complete and successful. The server may also transmit the price of the charging service (including the price that the employee is responsible for, if any, and the price that that the employer pays), which may or may not be included in the authorization reply.

The charging stations 110A-N and 120A-L may each include a meter (which may be a time-of-use meter) that measures the amount of electricity transferred between an electric vehicle and a power grid. In another embodiment, a meter that is coupled, but not included in the charging station, measures the amount of electricity transferred between an electric vehicle and the power grid. For example, the meter may be included in a controller that is coupled with the charging station and may transmit the charging session data to the server for accounting.

The charging stations 110A-110N and 120A-120L transmit charging session data during, or after completion of a charging session, to the server 140 for accounting and billing. The charging session data indicates the parameters of the charging session that, among other things, allows the server to determine the value of the taxable fringe benefit of the charging service provided by the employer. The charging session data may include one or more of the following: the charging station identifier, a charging connection type, the access identifier of the charging session, an employer identifier, the charging session start time, the charging session stop time, and the amount of energy consumed by an electric vehicle of an electric vehicle operator during the charging session.

After receiving the charging session data, the server 140 determines the value of the taxable fringe benefit provided to the employee. In one embodiment, the value of that taxable fringe benefit is stored in a profile associated with the employee, and is included in the employee's wages and reported to the appropriate taxing authorities. In one embodiment, the server 140 automatically reports the value of the taxable fringe benefit to the employer to allow the employer to include it in the wages of the employee and perform any withholding as necessary. In another embodiment, the server 140 automatically reports the value of the taxable fringe benefit to a payroll service that is contracted by the employer that includes the value in the wages of the employee and performs withholding as necessary.

In one embodiment, the server 140 determines the value of the taxable fringe benefit provided to the employee based on the FMV of the charging service. In general, the FMV of the charging service is the amount a willing electric vehicle operator (buyer) would pay for electric vehicle charging service from a seller where neither the operator nor seller is under compulsion to enter into the transaction and both have reasonable knowledge of the facts of the transaction. The FMV calculation of the electric vehicle charging service may be different depending on the way the electric vehicle charging service is priced. In one embodiment, the server 140 determines the FMV of electric vehicle charging service based on an average price that sellers that share similar circumstances (e.g., similar geographic areas, similar customers, similar charging type (e.g., level 1 charging that is typically at 120 volts, level 2 charging that is typically between 208-240 volts, level 3 charging that is typically between 300-600 volts DC, etc.)) charge for electric vehicle charging service. The value of the taxable fringe benefit is reduced by any amount that is paid by the employee.

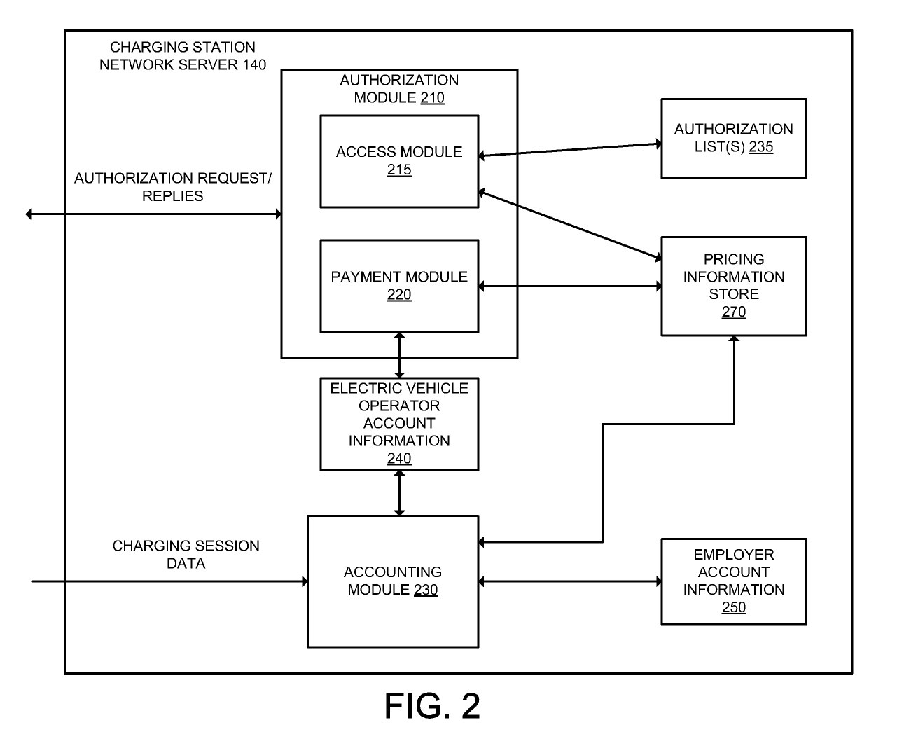

FIG. 2 is a block diagram illustrating the server 140 in more detail according to some embodiments. In particular, FIG. 2 illustrates an exemplary authorization and accounting procedure performed by the server 140. The authorization module 210 includes the access module 215 and the payment module 220. The access module 215 determines whether an access identifier presented by an electric vehicle operator is authorized to use the charging station at the time of the request. If the access identifier is authorized to use the charging station and payment is required to be authorized, the payment module 220 determines whether proper payment credentials have been presented or the account associated with the access identifier is otherwise in good standing.

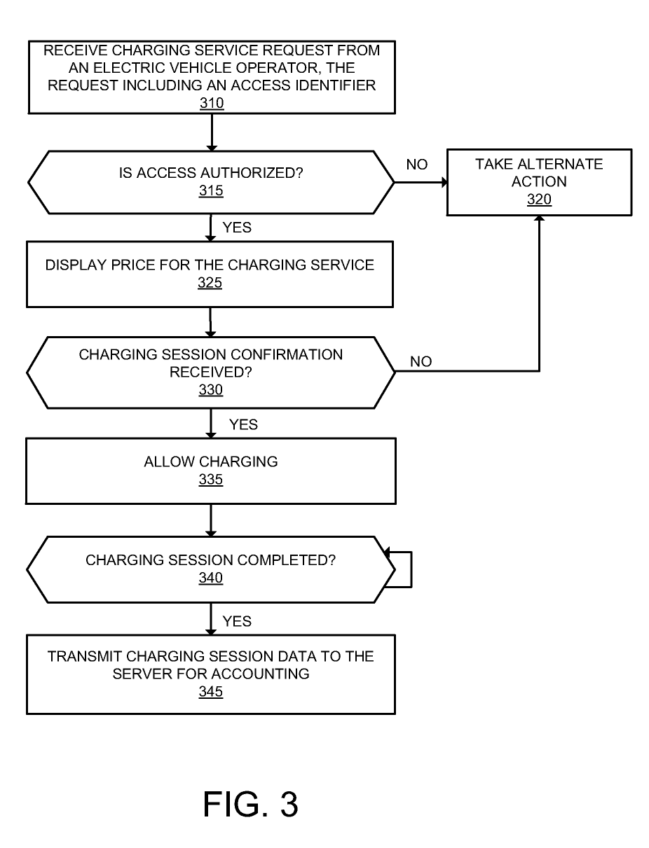

FIG. 3 is a flow diagram illustrating exemplary operations performed at a charging station according to one embodiment. The operations described in FIG. 3 will be described with reference to the exemplary embodiments discussed with reference to FIG. 2. However, it should be understood that the embodiments discussed with reference to FIG. 2 can perform operations different than those discussed with respect to FIG. 3, and the operations of FIG. 3 can be performed by embodiments other than those discussed with reference to FIG. 2.

At operation 310, the charging station receives a request for charging service from an electric vehicle operator. The request includes an access identifier associated with the electric vehicle operator. The request may be made in different ways. For example, the request may be made by the electric vehicle operator by waving or swiping an RFID tag (e.g., from a smartcard, contactless credit card, etc.) near the charging station. The electric vehicle operator may also present the access identifier differently (e.g., using a user interface of the charging station, using a remote application (e.g., an application on a mobile phone or laptop), through the electric vehicle (e.g., the vehicle's VIN transmitted through PLC), etc.). The access identifier may be a username/password, an email address, a phone number, an address, a credit card number, account number, PIN (personal identification number), or any other identifying information associated with the electric vehicle operator. The request may also be generated by the electric vehicle and may be an identifier associated with the electric vehicle (e.g., the vehicle's VIN). While operation 310 has been described with reference to the charging station receiving the request for charging service, in other embodiments different entities receive the charging service request (e.g., a controller coupled with the charging station, a payment station coupled with the charging station, a server coupled with the charging station, etc.). Flow moves from operation 310 to operation 315.

At operation 315, a determination is made whether access for the requested charging service is authorized. In one embodiment, this determination includes transmitting an authorization request to the server to perform an authorization procedure. The authorization request includes the access identifier associated with the electric vehicle operator and may include a charging station identifier that uniquely identifies the charging station. The authorization request may also include the time of the charging service request (or the time of the request may be estimated by the server based on the arrival of the authorization request). The authorization request may also include a charging connection type identifier that identifies the type of charging connection the request is for. With respect to FIG. 2, the authorization module 210 receives the authorization request.

The server determines whether access is authorized based at least in part on the access identifier. For example, the server compares the access identifier against a list of identifiers applicable for the charging station or charging connection type that are allowed to use the charging station to determine whether access is authorized. Alternatively, the server compares the access identifier against a list of identifiers that are not allowed to use the charging station or charging connection type. The server transmits an authorization reply to the charging station indicating whether the charging service is authorized. By way of a specific example, with reference to FIG. 2, the access module 215 determines if the access identifier is on a list of unauthorized identifiers by accessing the authorization list(s) 235 and/or is on a list of authorized identifiers in the list(s) 235. For example, the server 140 may maintain a list of identifiers that are known to be associated with fraudulent accounts or accounts that are otherwise not in good standing. If the access identifier is on such a list, then the access module 210 transmits an authorization fail reply message back to the charging station.

The server may also determine the price for the requested service. The price may reflect employee pricing if applicable. For example, the server may determine whether the access identifier is associated with employee pricing and determine the price (if any) of the service that is to be paid by the employee and the price that the employer pays. For example, with respect to FIG. 2, the payment module 220 may access the pricing information store 270 to determine the price for the requested service. By way of a specific example, the payment module 220 accesses the pricing information store 270 based on the access identifier and/or employer identifier in the authorization request to determine whether employee pricing is applicable and its parameters. After determining whether employee pricing is applicable, then based on the charging station identifier and/or the charging connection type (and possibly based on the time and/or date or other parameters), the payment module 220 determines the price for the requested charging service, including the amount paid by the employer and the amount (if any) that the employee is responsible for.

The authorization module 210 also determines whether payment authorization is required. For example, the authorization module 210 determines whether the employee is responsible for at least a portion of the payment and the type of access identifier indicates that payment needs to be validated before service commences. For example, the authorization module 210 derives from the type of access identifier whether the payment is validated before the start of the service (e.g., if paying with a pre-paid account, credit card, etc.). By way of a specific example, if the employee is paying for their portion of the service with a credit card (e.g., the employee swiped/waved or entered a credit card number when requesting the charging service) a credit payment authorization procedure may be performed to determine if the credit card is accepted. As another example, if the employee is paying through a pre-paid account, a payment authorization is performed to determine whether there is sufficient balance in the account. For example, the payment module 220 may access the electric vehicle operator account information 240 that stores account information including the current balances for electric vehicle operators, to determine whether there is sufficient credit for the charging session. If payment authorization is not required (e.g., the employer is paying for all of the service, the employee is paying for their portion in cash, etc.), then no payment authorization is required.

The accounting and billing may also be performed prior to the charging service commencing (i.e., prior to allowing energy being consumed by an electric vehicle). For example, if the employee is using a pre-paid account and is paying per session, the total cost owed by the employee (depending on the employee pricing) will be deducted from that pre-paid account (e.g., withdrawn from the employee's account) and placed into an account for the employer (or other holding account until at least a certain amount of energy is transferred). As another example, if the employee is paying using a pre-paid account and is paying per hour, the total cost (depending on employee pricing and the estimated duration of the charging session) will be deducted from that pre-paid account and placed into an account for the employer (or other holding account until at least a certain amount of energy is transferred). If the employer is not also the host, any amount owed by the employee is deducted from an account of the employee (or in certain circumstances the employer) and placed into an account for the host (or other holding account until at least a certain amount of energy is transferred), and any amount owed by the employer may be deducted from an account of the employer and placed into an account for the host (or other holding account until at least a certain amount of energy is transferred).

As described above, the employer may configure a limit on the amount that it will pay for an employee's personal charging service (e.g., a daily limit, a weekly limit, a monthly limit, and/or a yearly limit, etc.). In one embodiment, the server transmits a message to the charging station that indicates the remaining limit that will paid by the employer. The charging station is configured to automatically stop charging when the limit is reached, until the employee provides additional funds or agrees to pay for the additional charging service. The price and/or limit may be transmitted to the service along with the authorization reply (if authorized).

In another embodiment, the charging station (or other locally connected entity such as a controller) determines whether access is authorized. For example, the charging station may include a whitelist of identifiers that are allowed to use the charging station and/or a blacklist of identifiers that are not allowed to use the charging station. The charging station can compare the access identifier against the list(s) to determine whether access is authorized. The charging station can also base the determination on the time/date of the request. In addition, the charging station may store information that allows it to determine the parameters of the employee pricing if applicable.

If access is authorized, then flow moves from operation 315 to operation 325; otherwise flow moves to operation 320 where alternative action is taken (e.g., a message is displayed to the electric vehicle operator indicating that authorization has been denied). At operation 325, the charging station displays the price for the charging service. The price reflects what the employee is responsible for (if any) and what the employer will pay for (assuming that the identifier is associated with employee pricing). The remaining limit that the employer will pay for charging service may also be displayed. The charging station may also display multiple prices for multiple payment options (e.g., pay per charging session, pay per amount of time, pay per amount of energy, etc.). While operation 325 has been described with respect to the charging station displaying the price, in an alternative embodiment an entity coupled with the charging station displays the price (e.g., a payment station coupled with the charging station).

Flow then moves to operation 330 where if a charging service confirmation is received, then flow moves to operation 330, otherwise flow moves back to operation 320 where alternative action is taken (e.g., a message is displayed to the operator that the charging service request has been cancelled, etc.). The confirmation indicates that the electric vehicle operator wants to continue with the charging service (e.g., the price(s) are acceptable for the electric vehicle operator). The confirmation may be received in a similar way as the charging service request. For example, the electric vehicle operator may wave/swipe an RFID enabled device near the RFID reader to confirm the charging service, use a user interface of the charging station (or a payment station coupled with the charging station) to indicate confirmation, etc. If there are multiple payment options presented (e.g., pay per session, pay per amount of time, pay per amount of energy), the confirmation also includes a selection of one of those payment options. If a confirmation has been received, then flow moves to operation 335.

At operation 335, the charging station allows charging. For example, the charging station energizes the charging connection type thereby allowing energy to flow between the charging station and a power grid. Flow then moves to operation 340 where the charging station determines whether the charging session has completed. For example, the electric vehicle operator may indicate a termination of the charging session. The charging session may also automatically end upon expiration of a predefined time period.

When the charging session expires, then flow moves to operation 345 and the charging station transmits charging session data to the server for accounting. The charging session data may also be transmitted to the server periodically during the charging session. The charging session data indicates the parameters of the charging session that, among other things, allows the server to determine the value of the taxable fringe benefit of the charging service paid by the employer. The charging session data may include one or more of the following: the access identifier associated with the charging session, the charging station identifier, a charging connection type, an employer identifier, the charging session start time, the charging session stop time, and the amount of energy consumed by an electric vehicle of an electric vehicle operator during the charging session. The charging station may include a meter (which may be a time-of-use meter) that measures the amount of electricity transferred between an electric vehicle and a power grid. In another embodiment, a meter that is coupled, but not included in the charging station, measures the amount of electricity transferred between an electric vehicle and the power grid. For example, the meter may be included in a controller that is coupled with the charging station and may transmit the charging session data to the server for accounting.

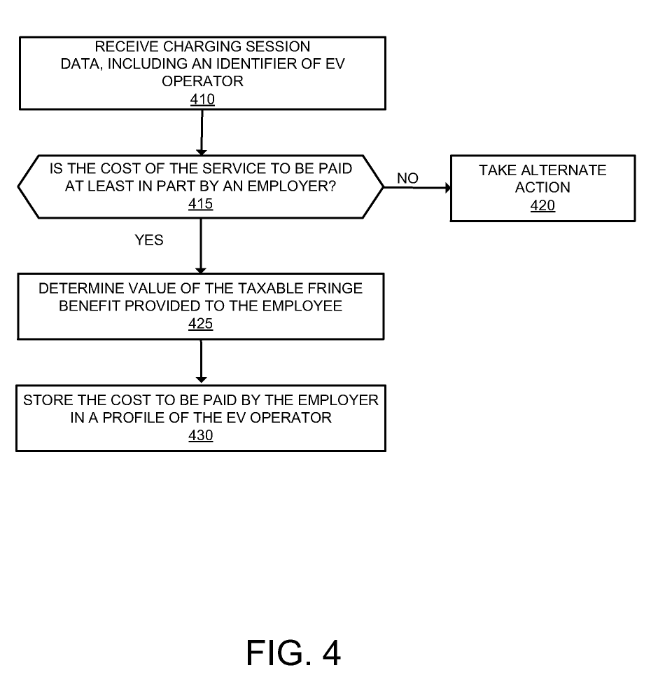

FIG. 4 is a flow diagram illustrating exemplary operations for an accounting procedure for employee pricing according to one embodiment. The operations described in FIG. 4 will be described with reference to the exemplary embodiments discussed with reference to FIG. 2. However, it should be understood that the embodiments discussed with reference to FIG. 2 can perform operations different than those discussed with respect to FIG. 4, and the operations of FIG. 4 can be performed by embodiments other than those discussed with reference to FIG. 2.

At operation 410, the server 140 receives charging session data (e.g., the charging session data transmitted in operation 345) for a charging session associated with an employee. With respect to FIG. 2, the accounting module 230 receives the charging session data. Flow then moves to operation 415.

At operation 415, the server 140 determines whether the cost of the charging service indicated in the charging session data is to be paid at least in part by an employer. For example, the server 140 determines whether the access identifier is associated with employee pricing. By way of example, the server 140 may compare the access identifier with a list of identifiers that have been indicated by an employer to qualify for employee pricing (e.g., the identifier is included in a RFID card assigned to the employee, the employee has properly registered the access identifier for employee pricing, etc.). By way of a specific example, with respect to FIG. 2, the accounting module 230 accesses the pricing information store 270 based on the access identifier and/or the employer identifier included in the charging session data to determine whether employee pricing is applicable. If at least part of the cost of the service is to be paid by an employer, then flow moves to operation 425, otherwise flow moves to operation 420 where alternative action is taken (e.g., the electric vehicle operator is billed for the cost of the service).

At operation 425, the server 140 determines the value of the taxable fringe benefit provided to the employee. For example, the accounting module 230 of the server 140 access the accesses the pricing records of the employer (e.g., stored in the pricing information store 270) to determine the employee charging service rate that applies for the particular employee, and based on the charging session data, determines the FMV of the service reduced by any amount not paid by the employer (e.g., reduced by the amount paid by the employee). For example, if the FMV of the service is ten dollars and the employee has paid (or will be billed) three dollars, the value of the taxable fringe benefit of the service provided to the employee is seven dollars.

In one embodiment, the accounting module 230 determines the FMV of electric vehicle charging service based on an average price that sellers that share similar circumstances (e.g., similar geographic areas, similar customers, similar charging type (e.g., level 1 charging that is typically at 120 volts, level 2 charging that is typically between 208-240 volts, level 3 charging that is typically between 300-600 volts DC, etc.)) charge for electric vehicle charging service. If, for example, hosts do not charge for electric vehicle charging service, the FMV of the electric vehicle charging service may be based on the price (typically set by an electric utility) for the amount of energy transferred during the charging session.

The FMV calculation of the electric vehicle charging service may be different depending on the way the electric vehicle charging service is priced. For example, the FMV of charging service that is priced based on a per charging session basis (irrespective of the actual amount of energy transferred) is determined based on the amount a willing electric vehicle operator would pay for a charging session at a similarly situated charging station. As another example, the FMV of charging service that is priced based on per hour of use (or other length of time) may be determined based on the amount that a willing electric vehicle operator would pay for electric vehicle charging service at a similarly situated charging station that is billed per hour (or other length of time). As yet a further example, the FMV of the charging service that is priced based on the amount of energy transferred during the charging session is determined based on the amount that a willing electric vehicle operator would pay for electric vehicle charging service at a similarly situated charging station that is billed based on the amount of energy transferred. The FMV of the charging service also may include an associated parking space, which may be determined based on the usual rate the hosts charge non-employees for the parking space that share similar circumstances.

Flow then moves to operation 430 and the value of the taxable fringe benefit provided to the employee is stored in a profile associated with the employee. For example, the value of the taxable fringe benefit may be stored in the electric vehicle operator account information 240. This value may be included in the employee's wages for reporting to the appropriate taxing authorities. For example, the total taxable fringe benefit for personal electric vehicle charging provided by the employer for a particular employee over a year is included in the wages of the employee and reported on a wage and tax statement, and, with respect to the United States, is generally subject to Federal income tax withholding, social security (unless the employee has already reached the current year wage base limit), and Medicare. In one embodiment, the employee may access their profile to check their usage.

In one embodiment, the value of the taxable fringe benefit provided to the employee is also stored in a profile associated with the employer. For example, it may be stored in the employer account information 250 such that the employer can review the cost of the charging service it is providing its employees. The information may be stored on a per-employee basis.

In one embodiment, the value of the taxable fringe benefit is automatically reported to the employer to allow the employer to include in the wages of the employee. In another embodiment, the value of the taxable fringe benefit is automatically reported to a payroll service that is contracted by the employer that will include the value in the wages of the employee.

In one embodiment, the accounting module 230 is also configured to request payment from the employer for the cost of electric vehicle charging service it is paying for its employees. For example, the employer may have an account that is debited accordingly. As another example, an invoice is sent to the employer for the cost of electric vehicle charging service it is paying, which may include the cost of the energy consumed from the power grid due to the charging service.

In one embodiment, the accounting module 230 is also configured to request payment from the employee for the cost of electric vehicle charging service that is not paid by its employer (if not already requested and paid for). For example, the employee may have a pre-paid account that is debited accordingly. As another example, an invoice is sent to a payment source of the employee. As another example, a credit card of the employee is charged accordingly.

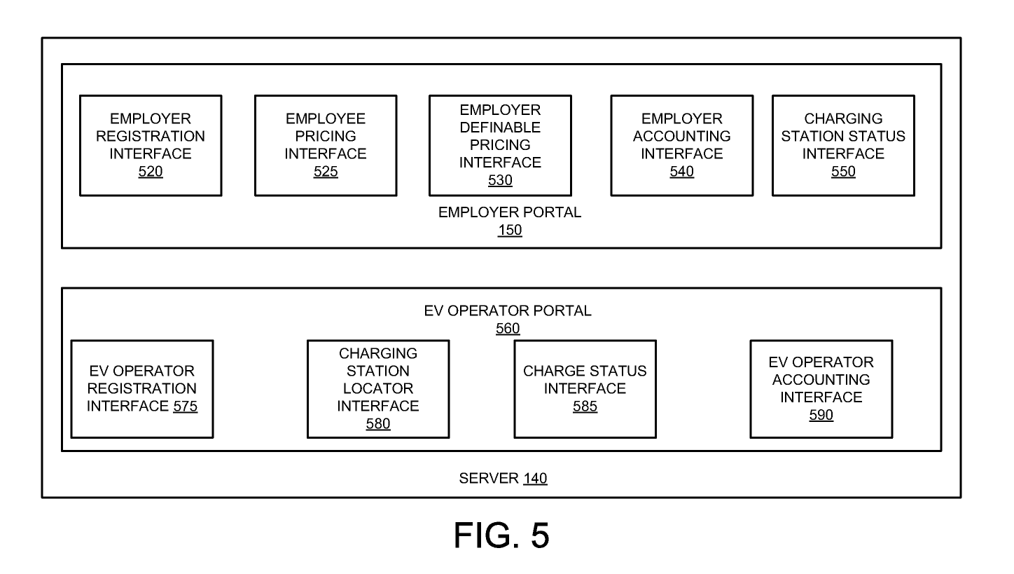

As described above, employers may use the employer portal 150 of the server 140 when configuring employee pricing. FIG. 5 illustrates exemplary portals of the server 140 including the employer portal 150 and the electric vehicle operator portal 560. As illustrated in FIG. 5, the employer portal 150 includes the employer registration interface 520, the employer definable pricing interface 530, the employer accounting interface 540, and the charging station status interface 550. Although not illustrated in FIG. 1 or 5, it should be understood that the server 140 includes database(s) (or accesses remote database(s)) or other storage mechanism that stores charging station configuration data, employee information, charging session data, employer account information, electric vehicle operator account information, and other information.

The employer registration interface 520 allows employers to register for service with the server 140, which may include registering their charging station(s) (if any) with the server 140. For example, the employer registration interface 520 allows employers to provide contact information (e.g., name, company, address, email address(es), telephone number(s), charging station serial numbers, etc.). Each employer may also be assigned an employer identifier to distinguish between different employers. Although not illustrated, it should be understood that the employer portal is restricted to employers having proper credentials typically established during registration (e.g., username/password, etc.). In some embodiments, a third party may register the stations on behalf of an employer. Such third parties may include an installer accessing an Installer Portal, or the network operator accessing a Network Operator Portal.

The employee pricing interface 525 allows employers to register their employees for employee pricing and define the parameters of the employee pricing. In one embodiment, an employer uses the interface 525 to provide a list of access identifiers that are associated with employees (e.g., employee names, employee numbers, etc.) that are authorized for employee pricing. For example, a particular employee may be associated with a particular access identifier that is to be used when requesting charging service for personal use. The employer may also use the interface 525 to define, on a global or a per employee basis, the parameters of the employee pricing as described above (e.g., how much it will pay for electric vehicle charging service, which may differ based on time/date, location, charging station, charging connection type, employee, etc.). The employer may also define where (e.g., which charging stations) the employee pricing will be valid at. For example, if the employer owns or controls charging station(s), the employer may configure the employee pricing to be only valid at its charging stations. As another example, the employer may configure the amount that the employer is willing to pay for electric vehicle charging service at charging stations other than one it owns or controls (e.g., charging stations of a different host).

The employer definable pricing interface 530 allows the hosts 105 and 115 to establish, for each of the charging stations 110A-110N and 120A-120L and/or charging station connections respectively, the non-employee price(s) for charging electric vehicles using those charging stations and/or charging station connections. The employer definable pricing interface 530 allows hosts to flexibly establish non-employee pricing for charging service that uses their charging stations. Thus the employer definable pricing interface 530 provides several different pricing options for which the hosts can configure.

The employer accounting interface 540 allows employers to review accounting information related to electric vehicle charging service. The accounting information may include one or more of the following: the amount paid for its employees' personal use of charging service (which may also be broken out per employee); the energy transferred through each of their charging station(s) (if any), the total amount of energy transferred from the power grid by each of their charging station(s) (if any) over a give time period; account balances, and payment and invoices, etc.). For example, the employer accounting interface 540 allows employers to access the employer account information store 250 to review account information. In some embodiments, the employer accounting interface 540 allows employers to review accounting information related to the cost of the electric vehicle charging service paid by the employer for its employees' personal use (which may be on a per-employee basis) and the value of the taxable fringe benefit provided to each employee for the electric vehicle charging service. This information may be used by the employer when reporting the value of the taxable fringe benefit to a payment service and included in the wages of the employee.

The charging station status interface 550 allows employers that are hosts to view the charging status of each of their charging station(s) (e.g., present status (charging, available, out-of-service), reports on occupancy rates of their charging station(s), reports on energy usage for each of their charging station(s), etc.).

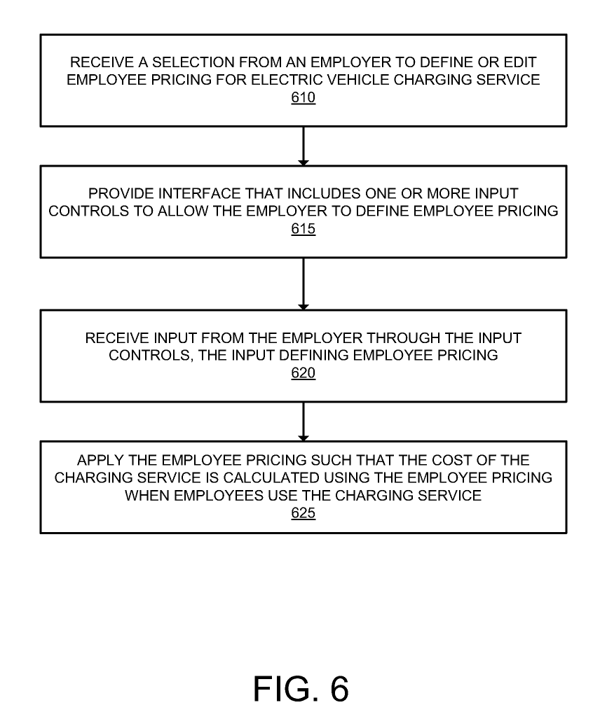

FIG. 6 is a flow diagram illustrating exemplary operations for defining employee pricing according to one embodiment. FIG. 6 will be described with reference to the exemplary embodiment of FIG. 1; however it should be understood that the operations described in reference to FIG. 6 can be performed by embodiments other than those discussed in reference to FIG. 1 and the embodiments discussed with reference to FIG. 1 can perform operations different than that described in reference to FIG. 6.

At block 610, the employer portal 150 receives a selection from an employer to define or edit employee pricing for electric vehicle charging service. By way of example, the employer accesses a portion of the employer portal 150 for defining or editing employee pricing for electric vehicle charging service (e.g., the employee pricing interface 525). Flow moves from block 610 to block 615.

At block 615, the employer portal 150 provides a set of one or more input controls to allow the employer to define employee pricing for personal use of electric vehicle charging service. For example, the input controls can include pricing controls (e.g., to indicate how much the employer will pay for the charging service). As previously described, the pricing may further be defined based on the time of day and/or date. Thus in addition to the pricing controls, in some embodiments the input controls provided to the employers include time of day input fields to allow the employers to set time periods that employee prices will apply, and/or day/date fields to allow the employers to set days/dates that employee prices will apply (e.g., weekdays, weekends, holidays, custom date and time, etc.). In addition, the employers may further define the employee pricing globally or on a per-employee basis (based on the access identifier presented during the request that is associated with the employee). Thus in some embodiments, the input controls also include an access identifier control to allow the employers to provide one or more access identifiers that are eligible for employee pricing. In addition, the employers may further define the employee pricing based on the type of charging connection. For example, the employers may define separate prices that it will pay for separate charging connection types. Thus in some embodiments, the input controls also include a charging connection type input control to allow the employers to define employee pricing for separate charging connection types.

Flow moves from block 615 to block 620, where the employer portal 150 receives input from the employer through the input controls, where the input defines the employee pricing. The input defines employee pricing for electric vehicle charging service for one or more of its employees. The input can also indicate time of day(s) and/or date(s) that the employee pricing applies. The input can also indicate different employee pricing for different employees (e.g., identified by access identifiers), which may further be based on time of day and/or date. It should be understood that the above are examples of the input and the employer may flexibly combine different types of input to define employee pricing. Flow then moves to block 625, where the employer portal 150 causes the employee pricing to be applied such that cost of the charging service is calculated using the defined employee pricing when employees use charging service.

Referring back to FIG. 5, the server 140 also includes the electric vehicle operator portal 560. The portal 560 includes the electric vehicle operator registration interface 575, the charging station locator interface 580, the charge status interface 585, and the electric vehicle operator accounting interface 590. The electric vehicle operator registration interface 575 allows potential customers (e.g., electric vehicle operators) to sign up for charging services. For example, the electric vehicle operator registration interface 575 collects contact point information from electric vehicle operators (e.g., name, address, email address, telephone number, etc.), type of electric vehicle(s) and/or type of electricity storage device, and service plan information.

In one embodiment, the interface 575 allows employees to register for employee pricing. For example, the interface 575 allows the employees to authenticate that they are an employee (e.g., the employees are given a username/password in order to access the functionality of the interface 575) and register for employee pricing. The employees may choose an access identifier (e.g., username/password, credit card number, email address, or other unique identifier) that will be used for employee pricing. In one embodiment, employees can use the interface 575 to register their personal electric vehicles for the service by providing a VIN (vehicle identification number) or other identifier associated with their personal electric vehicles. The employee registration may need to be confirmed by a supervisor before being applied.

In some embodiments of the invention, the electric vehicle operator registration interface 575 also allows operators to provide notification message preferences for receiving notification messages upon certain events occurring. For example, each operator may provide a notification message preference to receive notification messages for each event that interests them (those events the operator wishes to receive notification messages on). The events of interest may include one or more suspension or termination of a charging session events, one or more charge status events, one or more update events, one or more parking events, and/or one or more alarm events. For example, each operator may provide a notification message preference for an event in interest (whether they want to receive a notification message for that event) for the following events: fully charged vehicle, charging has been interrupted (e.g., the charging cord has been removed from the vehicle or has been severed, the station has encountered a power loss, etc.), charging has completed, charging is nearing completion, the utility operating the power grid has caused their charging of the vehicle to be suspended (e.g., the load on the grid exceeded a Demand Response threshold), the operator forgot to plug in their charging cord into their vehicle, etc. The vehicle operators may choose to receive one or any combination of the above events that interest them. In addition, the operators may be able to choose the format of the notification messages (e.g., receive through email, through text message, etc.). In addition, the operators may provide one or more contact points specific for notification messages (e.g., email address(es), text message address(es) (e.g., phone number(s)), etc.). It should also be understood that one or more events may have default notification message preference values.

The charging station locator interface 580 allows electric vehicle operators to locate charging stations (available and/or unavailable charging stations). In one embodiment, the charging station locator interface 580 allows the electric vehicle operators to restrict or refine the search or charging stations based on price and/or charging connection type. The charging station locator interface 580 may provide an interactive map for the vehicle operators to locate charging stations. The charging station locator interface 580 may also provide an estimated time when the charging station will become available for use. Electric vehicle operators may also use the charging station locator interface 580 to create a list of favorite charging station(s) for the server 140 to monitor their availability and notify the user (e.g., through email or text message) when those charging station(s) are available and/or unavailable. In addition, in some embodiments of the invention, the operators may use the charging station locator interface 580 to reserve charging stations for future use.

The charge status interface 585 allows operators to determine the charging status of their electric vehicles (that are currently being charged). According to one embodiment of the invention, the charge status interface 585 presents charge status information to the operator (e.g., amount of power currently being transferred, total amount of power transferred, amount of energy transferred, total amount of energy transferred, the amount of time the charging session has lasted, an estimate of the time left to charge their vehicle, etc.).

The electric vehicle operator accounting interface 590 allows operators to review accounting information related to their charging service usage (e.g., the number of sessions remaining in their subscription, payment and/or invoice information, the amount of pre-paid credits remaining, etc.), and/or generate report(s) (e.g., illustrating power consumed from the power grid, illustrating an estimate of the amount of gasoline saved through use of their electric vehicle(s), illustrating an estimate of the amount of greenhouse gases they have saved from outputting through use of their electric vehicle(s), illustrating the amount of money saved in gasoline costs through use of their electric vehicle(s), etc.). In addition, the electric vehicle operator accounting module 590 may allow electric vehicle operators to review a history of the charging station(s) that they most often use. The electric vehicle operator accounting interface 590 may also allow the electric vehicle operators to add credits to a pre-paid account.

In one embodiment, the interface 590 also allows operators to review accounting information related to the employee pricing. In particular, an employee can use the interface 590 to view the taxable fringe benefit that has been provided by their employer for charging service (and thus will be included on the employee's wages).

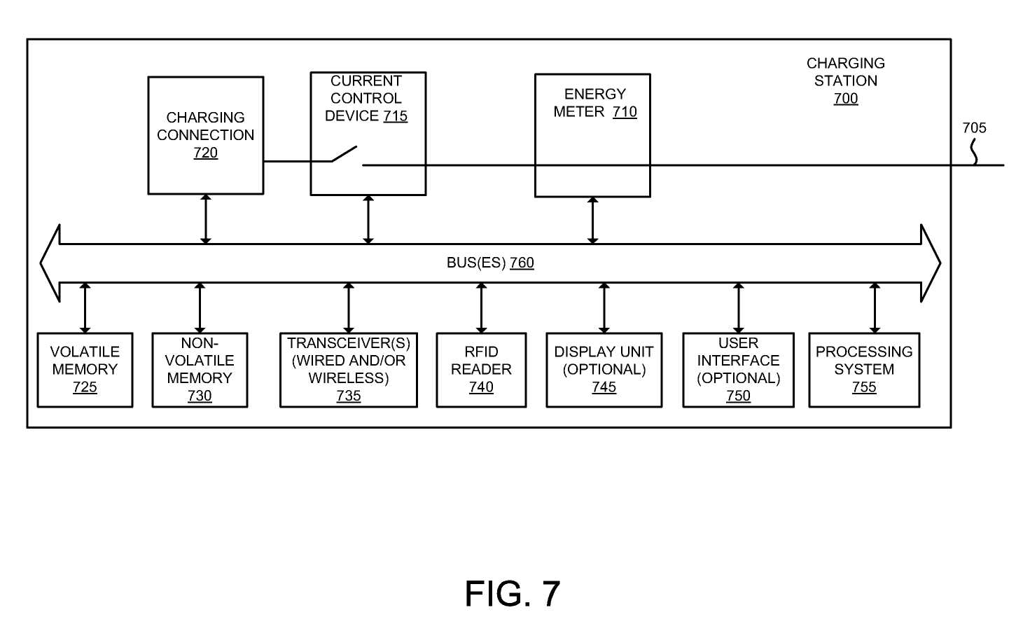

FIG. 7 illustrates an exemplary embodiment of a charging station according to one embodiment of the invention. It should be understood that FIG. 7 illustrates an exemplary architecture of a charging station, and other, different architectures may be used in embodiments of the invention described herein. For example, one or more of the components illustrated in FIG. 7 may not be included in some embodiments.

As illustrated in FIG. 7, the charging station 700 includes the energy meter 710, the current control device 715, the charging connection 720, the volatile memory 725, the non-volatile memory 730 (e.g., hard drive, flash, PCM, etc.), one or more transceiver(s) 735 (e.g., wired transceiver(s) such as Ethernet, power line communication (PLC), etc., and/or wireless transceiver(s) such as 802.15.4 transceivers (e.g., ZigBee, etc.), Bluetooth, WiFi, Infrared, GPRS/GSM, CDMA, etc.), the RFID reader 740, the display unit 745, the user interface 750, and the processing system 755 (e.g., one or more microprocessors and/or a system on an integrated circuit), which are coupled with one or more buses 760.

The energy meter 710 measures the amount of electricity that is flowing on the power line 705 through the charging connection 720. While in one embodiment of the invention the energy meter 710 measures current flow, in an alternative embodiment of the invention the energy meter 710 measures power draw. The energy meter 710 may be an induction coil or other devices suitable for measuring electricity. In some embodiments, the energy meter 710 is a programmable time of use energy meter (e.g., programmed according to the prices and time periods defined by its host).

The charging connection 720 is a power receptacle or circuitry for an attached charging cord (e.g., with a SAE J1772 connector). The power receptacle can be any number of types of receptacles such as receptacles conforming to the NEMA (National Electrical Manufacturers Association) standards 5-15, 5-20, and 14-50 or other standards (e.g., BS 1363, CEE7, etc.) and may be operating at different voltages (e.g., 120V, 240V, 230V, etc.).

The current control device 715 is a solid-state device that is used to control the current flowing on the power line 705 or any other device suitable for controlling the current flowing on the power line 705. For example, in some embodiments the current control device 715 energizes the charging connection 720 (e.g., by completing the circuit to the power line 705) or de-energizes the charging connection 720 (e.g., by breaking the circuit to the power line 705). In some embodiments the current control device 715 energizes the charging connection 720 responsive to receiving an authorized request from an electric vehicle operator.

The RFID reader 740 reads RFID tags from RFID enabled devices (e.g., smartcards, key fobs, contactless credit cards, etc.), embedded with RFID tag(s) of operators that want to use the charging station 700. For example, in some embodiments a vehicle operator can wave/swipe an RFID enabled device near the RFID reader 730 to request a charging session with the charging station 700. It should be understood, however, that charging sessions may be requested in different ways and access identifiers may be presented to the charging station in different ways. For example, in some embodiments the electric vehicles communicate an access identifier (e.g., their VIN) to the charging station through a protocol (e.g., PLC). In such embodiments, the electric vehicle operator may not be required to present an access identifier (such as the RFID enabled device) to gain access to the charging station. However, it should be understood that the electric vehicle operators may use the RFID reader 740 for payment.

The transceiver(s) 735 transmit and receive messages. For example, the transceiver(s) 735 transmit authorization requests to the server, receive authorization replies from the server, transmit charging session data to the server for accounting, etc. The display unit 745 is used to display messages to vehicle operators including the price(s) for charging service, current cost for charging service, charging status, confirmation messages, error messages, notification messages, etc. The display unit 745 may also display parking information if the charging station 700 is also acting as a parking meter (e.g., amount of time remaining in minutes, parking violation, etc.).

The user interface 740 (which is optional) allows users to interact with the charging station 700. By way of example, the user interface 750 allows electric vehicle operators to request charging sessions, pay for charging sessions, enter in account and/or payment information, etc.

The processing system 755 may retrieve instruction(s) from the volatile memory 725 and/or the nonvolatile memory 730, and execute the instructions to perform operations as described above.

The techniques shown in the figures can be implemented using code and data stored and executed on one or more electronic devices (e.g., a charging station, a charging station network server, etc.). Such electronic devices store and communicate (internally and/or with other electronic devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

In addition, while embodiments have been described with respect to the server 140 being used to define employee pricing as well as perform authorization procedures and accounting procedures, one or more of these may be performed at different servers.

While embodiments have been described with respect to the server 140, which is owned and administered by a different entity than a host, in other embodiments the operations described herein (e.g., the operations described with respect to FIGS. 3 and 4) are performed by a device that is private and local to a host. For example, a host may install a server in their private network to automatically track the taxable fringe benefits provided to its employees due to employee pricing of electric vehicle charging service.

While embodiments have been described with reference to a server calculating the taxable fringe benefit for personal electric vehicle charging service use, in other embodiments, a charging station or other device (e.g., a controller coupled with the charging station) calculates the taxable fringe benefit for an employee's personal electric vehicle charging service use. In such embodiments, the charging station may locally store the taxable fringe benefit values and/or transmit those values for remote storage (e.g., on the server or at a different device).

In some embodiments, hosts can configure employee pricing to be limited only to its charging stations while in other embodiments hosts can configure employee pricing to be applicable for charging stations that are not owned or controlled by that host.

While embodiments have been described with respect to employees, in some embodiments the system described herein calculates and stores the value of electric vehicle charging service provided to independent contractors or other individuals for the purpose of tax accounting. By way of example, an employer may contract with an independent contractor and pays for at least part of their personal electric vehicle charging station use. In such a case, the server may calculate and store the amount paid by the employer for the independent contractor for the purposes of tax accounting and reporting.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method in a charging station network server, comprising:
receiving a message that indicates a set of one or more parameters of an electric vehicle charging session, wherein the set of parameters includes an indication of an electric vehicle operator associated with the charging session;
determining that at least a portion of a cost of the electric vehicle charging session is to be paid by an employer of the electric vehicle operator;
determining a fair market value of the electric vehicle charging session reduced by any amount that is not paid by the employer; and
storing, in association with a profile of the electric vehicle operator, the determined fair market value of the electric vehicle charging session reduced by any amount that is not paid by the employer.

2. The method of claim 1, wherein the set of parameters include an amount of energy consumed during the electric vehicle charging session, and wherein the fair market value of the electric vehicle charging session includes a cost of the amount of energy consumed.

3. The method of claim 1, further comprising:
reporting the determined fair market value of the electric vehicle charging session reduced by any amount that is not paid by the employer to a payroll service for inclusion in wages of the electric vehicle operator.

4. The method of claim 1, further comprising:
communicating to the employer the determined fair market value of the electric vehicle charging session reduced by any amount that is not paid by the employer.

5. The method of claim 1, wherein determining that the at least the portion of the cost is to be paid by the employer includes determining that the electric vehicle charging session is for personal use.

6. The method of claim 5, wherein determining that the electric vehicle charging session is for personal use includes determining that an access identifier that is included in the set of parameters is associated with employee pricing.

7. The method of claim 1, further comprising:
requesting payment for the at least the portion of the cost to be paid by the employer from a payment source associated with the employer.

8. The method of claim 5, further comprising:
wherein at least a portion of the cost of the electric vehicle charging session is to be paid by the electric vehicle operator; and
requesting payment for a portion of the cost to be paid by the electric vehicle operator from a payment source associated with the electric vehicle operator.

9. A server that is to be coupled with a plurality of electric vehicle charging stations, comprising:
a set of one or more processors of the server;
an accounting module, that when executed by the set of processors, cause the set of processors to perform the following:
determine, for each of a plurality of employees of an employer, a taxable fringe benefit value of that employee's personal use of electric vehicle charging service based on a fair market value of that electric vehicle charging service reduced by any amount to be paid by the employee, wherein the electric vehicle charging service includes an amount of energy drawn by an electric vehicle through one of the plurality of electric vehicle charging stations, and
store, for each of the plurality of employees, the determined taxable fringe benefit value.

10. The server of claim 9, wherein the fair market value of the electric vehicle charging service includes a cost of the amount of energy drawn.

11. The server of claim 9, wherein the accounting module, when executed by the set of processors, is further to report the taxable fringe benefit value associated with each employee to a payroll service for inclusion in wages of that employee.

12. The server of claim 9, wherein the accounting module, when executed by the set of processors, is further to communicate to the employer the taxable fringe benefit value associated with each employee.

13. The server of claim 9, wherein the accounting module, when executed by the set of processors, is further to request payment from the employer for a cost of each of its employees' personal use of electric vehicle charging service attributed to the employer.

14. The server of claim 9, wherein the accounting module, when executed by the set of processors, is further to request payment from each employee the amount of electric vehicle charging service

15. A non-transitory machine-readable storage medium that provides instructions that, when executed by a processor, will cause said processor to perform operations, comprising:
receiving a message that indicates a set of one or more parameters of an electric vehicle charging session, wherein the set of parameters includes an indication of an electric vehicle operator associated with the charging session;
determining that at least a portion of a cost of the electric vehicle charging session is to be paid by an employer of the electric vehicle operator;
determining a fair market value of the electric vehicle charging session reduced by any amount that is not paid by the employer; and
storing, in association with a profile of the electric vehicle operator, the determined fair market value of the electric vehicle charging session reduced by any amount that is not paid by the employer.

16. The non-transitory machine-readable storage medium of claim 16, wherein the set of parameters include an amount of energy consumed during the electric vehicle charging session, and wherein the fair market value of the electric vehicle charging session includes a cost of the amount of energy consumed.

17. The non-transitory machine-readable storage medium of claim 16 further including instructions, that when executed by the processor, cause said processor to perform the following operation:
reporting the determined fair market value of the electric vehicle charging session reduced by any amount that is not paid by the employer to a payroll service for inclusion in wages of the electric vehicle operator.

18. The non-transitory machine-readable storage medium of claim 16, further including instructions, that when executed by the processor, cause said processor to perform the following operation:
communicating to the employer the determined fair market value of the electric vehicle charging session reduced by any amount that is not paid by the employer.

19. The non-transitory machine-readable storage medium of claim 16, wherein determining that the at least the portion of the cost is to be paid by the employer includes determining that the electric vehicle charging session is for personal use.

20. The non-transitory machine-readable storage medium of claim 19, wherein determining that the electric vehicle charging session is for personal use includes determining that an access identifier that is included in the set of parameters is associated with employee pricing.

21. The non-transitory machine-readable storage medium of claim 16, further including instructions, that when executed by the processor, cause said processor to perform the following operation:
requesting payment for the at least the portion of the cost to be paid by the employer from a payment source associated with the employer.

22. The non-transitory machine-readable storage medium of claim 21, further including instructions, that when executed by the processor, cause said processor to perform the following operations:
wherein at least a portion of the cost of the electric vehicle charging session is to be paid by the electric vehicle operator; and
requesting payment for a portion of the cost to be paid by the electric vehicle operator from a payment source associated with the electric vehicle operator.
